(19) United States
(12) Patent Application Publication
(10) Pub. No.: US 2006/0191557 A1
(43) Pub. Date: Aug. 31, 2006

(54) Cleaning implement

(75) Inventors: Mark Rosenzweig, Chestnut Hill, MA (US); Terry Robertson, Auburn, AL (US)

Correspondence Address: SHOOK, HARDY & BACON L.L.P., 600 14TH STREET NW SUITE 800, WASHINGTON, DC, 20005-2004, US

(73) Assignee: EURO-PRO Operating LLC, Newton, MA (US)

(21) Appl. No.: 11/066,005

(22) Filed: Feb. 25, 2005

(51) Int. Cl. B08B 7/00

(52) U.S. Cl. 134/6; 15/228; 15/209.1

(57) ABSTRACT

A single layer cleaning pad is provided for cleaning a surface without separate application of a cleaning solution. The pad can be removably attached to a cleaning instrument for ease of use. Prior to use, the pad is stored in a vessel so that the pad is saturated with cleaning solution.

### FIELD OF THE INVENTION

This application relates to a cleaning implement comprising a handle and a removable cleaning pad saturated with a cleaning solution.

### BACKGROUND OF THE INVENTION

Conventional cleaning instruments with removable cleaning pads require the user to handle the cleaning pad both to place the pad on the cleaning head and to remove the pad. Such conventional cleaning pads are composed of multiple layers, such as two or more of a layer having a high adsorbency, a scrubbing layer, and/or a structural layer. The method of attaching the cleaning pad may require the pad to be wrapped around the cleaning head, possibly to reach one or more attachment points on the cleaning head. When a cleaning pad is wrapped around the cleaning head, a portion of the pad is not used to contact surfaces during cleaning. Depending on the design, as much as 40% of the cleaning pad may be unable to contact the surface being cleaned. Additionally, the user of the cleaning instrument must provide a separate cleaning solution if a wet cleaning method is desired.

U.S. Pat. No. 6,045,622 provides a method of cleaning which includes the steps of: a) applying a cleaning solution to a hard surface and b) wiping the hard surface with a cleaning implement having a removable cleaning pad having an absorbent capacity of at least about 1 g deionized water per g of the cleaning pad after soaking the pad for 20 minutes.

U.S. Pat. No. 6,048,123 provides a removable cleaning pad having two layers: a scrubbing layer and an absorbent layer. The cleaning pad has an absorbent capacity of at least about 10 g deionized water per g of cleaning pad and a squeeze-out value of not more than about 40% at 0.25 psi. A removable cleaning pad having 3 layers is also described.

U.S. Pat. No. 5,419,015 provides a three layer removable cleaning pad. The pad includes a top layer made of a Velcro fabric material, a central microporous foam plastic layer, and a lower layer composed of a fabric suitable for mopping a floor. The three layers are joined together by stitching around the perimeter of the pad.

What is needed is a cleaning instrument with a removable cleaning pad composed of a single layer. Additionally, the cleaning pad should be usable without having to apply a separate cleaning solution to the surface to be cleaned.

### SUMMARY OF THE INVENTION

In various embodiments, the invention provides a cleaning pad in a container that is saturated with a cleaning solution. After withdrawing the cleaning pad, the pad can be directly used to wipe a surface to be cleaned. The pad is saturated with cleaning solution, so a separate cleaning solution does not need to be applied. When finished with a cleaning pad, the cleaning pad can be removed so that a fresh cleaning pad can be attached to the cleaning head.

In other embodiments, the invention provides a single layer cleaning pad. The single layer cleaning pad has sufficient structural integrity that the pad can be saturated with cleaning solution prior to use. Additionally, when saturated the pad contains sufficient cleaning solution so that a separate cleaning solution is not required during cleaning.

In an embodiment, the cleaning pad comprises a single layer pad having a basis weight of at least 300 g/m², a tensile strength when saturated of at least 200 N, and an adsorbency of more than 6.5 and less than 8 grams of deionized water per gram of pad at saturation. At least one attachment material in the form of a hooks material or a loops material is fastened to a surface of the single layer pad.

In another embodiment, the cleaning pad comprises a single layer pad saturated with a cleaning solution, the cleaning pad having a basis weight of at least 300 g/m² and an adsorbency of more than 6.5 and less than 8 grams of deionized water per gram of pad at saturation. At least one attachment material in the form of a hooks material or a loops material is fastened to a surface of the single layer pad.

In various embodiments, the invention also provides a method for cleaning a surface using a single layer cleaning pad that is saturated with cleaning solution. Optionally, the single layer cleaning pad can be attached to the cleaning head of a cleaning instrument without requiring handling by the user.

In an embodiment, a vessel containing one or more cleaning pads is provided. The pads each include at least one attachment material and are saturated with cleaning solution. The cleaning head of a cleaning instrument is attached to the attachment material of one of the cleaning pads. The cleaning pad is then withdrawn from the vessel and a surface to be cleaned is wiped with the attached pad.

In still another embodiment, the invention provides a cleaning pad package assembly. The assembly includes a container with a hinged lid. Inside the container are a cleaning solution and a plurality of single layer pads saturated with the cleaning solution. The single layer pads have an adsorbency of more than 6.5 and less than 8 grams of deionized water per gram of pad. The single layer pads also include at least one attachment strip fastened to a surface of the pad.

### BRIEF DESCRIPTION OF THE DRAWINGS

FIG. 1 depicts a cleaning pad according to an embodiment of the invention.

FIGS. 2a and 2b provide views of a cleaning instrument according to an embodiment of the invention.

FIGS. 3a and 3b provide views of a container for storing cleaning pads according to an embodiment of the invention.

FIGS. 4a and 4b provide views of an alternative container for storing cleaning pads according to an embodiment of the invention.

### DETAILED DESCRIPTION OF THE EMBODIMENTS

I. General Description of Cleaning Pads and Methods of Use

This invention is directed to removable cleaning pads and methods for use of removable cleaning pads as part of a cleaning instrument. In describing the removable cleaning pads, the surface of the pad used to contact a surface to be cleaned will be referred to as the “bottom” surface, while the opposite surface will be referred to as the “top” surface.

In various embodiments, the cleaning pads of this invention are single-layer pads. Rather than having a plurality of layers, such as a cleaning layer for contacting a surface to be cleaned and a structural layer as a support for the cleaning layer, the inventive pads have only one layer. The cleaning pads according to the invention are composed of a material with sufficient structural integrity to serve as both a structural material and a cleaning material. A separate support layer is not required. The single layer pad also has sufficient structural integrity so that attachment strips or other attachment materials can be bonded directly to the pad. This allows the pad to be attached to the cleaning head of a cleaning instrument without having a separate structural, bonding, or attachment layer. In an embodiment, the cleaning pad can be attached to a mop that has a cleaning head adapted for attachment of the cleaning pad.

In an embodiment, the cleaning pads and the cleaning head include complementary attachment materials to allow a cleaning pad to be attached to the cleaning head. By attaching the cleaning pad to the cleaning head using complementary attachment materials, the full surface area of the bottom of the cleaning pad is available to contact a surface to be cleaned. In an embodiment, the complementary attachment materials are Velcro-type “hooks” and “loops” materials. Preferably, the attachment materials are in the form of strips. Each cleaning pad has at least one attachment strip or other attachment material on a surface of the pad, preferably on the top surface. The one or more attachment strips (or other attachment materials) can have any convenient shape and can be attached in any convenient orientation on the top surface of the cleaning pad. For example, for a cleaning pad in the shape of a rectangle, the attachment materials can comprise two parallel strips that traverse the long axis of the pad. In such an embodiment, the cleaning head of the cleaning instrument can have complementary attachment strips with the same shape and relative positioning to allow for attachment of the cleaning pad to the cleaning instrument.

Prior to use, the cleaning pads are stored in a vessel that contains a cleaning solution. The vessel contains enough cleaning solution so that the cleaning pads stored in the vessel are saturated with the cleaning solution. To use a cleaning pad, the cleaning pad is attached to the cleaning head via the attachment strips. The cleaning instrument can then be used to clean a desired surface. After cleaning, the pad can be removed by the user to allow for attachment of a new cleaning pad.

II. Description of the Cleaning Pad

In an embodiment, the cleaning pad has a basis weight of at least about 300 g/m², preferably at least 315 g/m², and more preferably at least 330 g/m² of pad surface area. In another embodiment, the cleaning pad has a basis weight of less than about 400 g/m², preferably less than 375 g/m², and more preferably less than 350 g/m² of pad surface area. The basis weight of the pad contributes to the pad having sufficient structural integrity to serve as a single layer pad. In an embodiment, the pad has a thickness of at least about 2.2 mm, preferably at least 2.5 mm, and more preferably at least 2.7 mm. In another embodiment, the pad has a thickness of less than about 3.6 mm, preferably less than 3.3 mm, and more preferably less than 3.0 mm.

The cleaning pad can have any length, width, and surface area that is convenient for use with a cleaning apparatus. In an embodiment, the length and/or width of the cleaning pad is at least 10 cm, or at least 20 cm, or at least 30 cm, or at least 40 cm, or at least 50 cm, or at least 75 cm. In another embodiment, the length and/or width of the cleaning pad is 100 cm or less, or 75 cm or less, or 50 cm or less, or 40 cm or less, or 30 cm or less, or 20 cm or less. In an embodiment, the surface area of the cleaning pad is at least 0.01 m², or at least 0.05 m², or at least 0.1 m², or at least 0.15 m², or at least 0.20 m². In another embodiment, the surface area of the cleaning pad is 0.25 m² or less, or 0.20 m² or less, or 0.15 m² or less, or 0.1 m² or less, or 0.05 m² or less. Note that “length” and “width” refer to the longest dimension of the pad along a direction, and do not necessarily imply that a pad has a rectangular shape. In various embodiments, the single layer pad can have a rectangular, oval, triangular, trapezoidal, or circular shape. In still another embodiment, the single layer pad can have any irregular shape convenient for cleaning that allows the single layer pad to retain its structural integrity.

The tensile strength of the cleaning pad when dry is at least 350 N, preferably at least 380 N, and more preferably at least 400 N. When saturated, the tensile strength of the cleaning pad is at least 200 N, preferably at least 230 N, and more preferably at least 250 N. These tensile strength values represent measurements made using an ISO-9073-3 compliant test method.

The elongation of the cleaning pad when dry is less than 75% and preferably less than 70% as measured using an ISO-9073-3 compliant test method. When saturated, the elongation of the cleaning pad is less than 65% and preferably less than 55% as measured using an ISO-9073-3 compliant test method.

In an embodiment, at saturation the cleaning pad can preferably adsorb at least 6 grams of deionized water per gram of pad, or at least 6.5 grams, or at least 7 grams. In another embodiment, at saturation the pad can adsorb not greater than 8 grams of deionized water per gram of pad, or not greater than 7.5 grams, or not greater than 7 grams. In still another embodiment, at saturation the pad can adsorb at least 6.5 grams of deionised water per gram of pad and not greater than 8 grams of deionised water per gram of pad. To measure the amount of adsorption at saturation, the cleaning pad can be immersed in deionized water for a period of 24 hours using an ISO-9073-6 compliant test method.

In an embodiment, the pad is composed of a non-woven material, such as a blend of 50% Viscose (i.e. rayon), 25% polyester, and 25% polypropylene. In another embodiment, the pad is composed of 75% rayon and 25% polypropylene. In still another embodiment, the pad is composed of 70%-80% rayon and 20-30% polypropylene. In yet another embodiment, the pad is composed of from 40% to 80% Viscose or rayon, 0-30% polyester, and 15-30% polypropylene. Other blends can be used, as long as the blend provides the pad with the physical properties described above.

In an embodiment, the pad is made by a needle-punch method. Needle-punching is a process of creating non-woven fabrics with a machine that automatically arranges and sets fibers. The interlocking of fibers to make a non-woven fabric is done by passing barbed needles back and forth through the fabric. An additional glue or chemical is not required to hold the material together.

In another embodiment, the pad can be composed of any of a variety of materials, so long as the resulting pad has an appropriate adsorbency and structural integrity. Materials that can be used to provide both structural integrity and adsorbency include synthetics such as polyolefins (e.g., polyethylene and polypropylene), polyesters, polyamides, manufactured cellulosics (such as rayon), and blends thereof. Such synthetic materials may be carded, spunbond, meltblown, airlaid, needlepunched, or otherwise conventionally processed to form the inventive cleaning pad.

Other adsorbent materials that can be incorporated into the cleaning pad include fibrous materials, such as those that are naturally occurring (modified or unmodified), as well as synthetically made fibers or manufactured fibers. Examples of suitable unmodified/modified naturally occurring fibers include cotton, Esparto grass, bagasse, kemp, flax, silk, wool, wood pulp, chemically modified wood pulp, jute, ethyl cellulose, and cellulose acetate. Suitable synthetic or manufactured fibers can be made from polyvinyl chloride, polyvinyl fluoride, polytetrafluoroethylene, polyvinylidene chloride, polyacrylics such as ORLON®, polyvinyl acetate, rayon, polyethylvinyl acetate, non-soluble or soluble polyvinyl alcohol, polyolefins such as polyethylene (e.g., PULPEX®) and polypropylene, polyamides such as nylon, polyesters such as DACRON® or KODEL®, polyurethanes, polystyrenes, and the like. The absorbent layer can comprise solely naturally occurring fibers, solely synthetic or manufactured fibers, or any compatible combination of naturally occurring, manufactured, and synthetic fibers.

The fibers useful herein can be hydrophilic, hydrophobic or can be a combination of both hydrophilic and hydrophobic fibers. As indicated above, the particular selection of hydrophilic or hydrophobic fibers will depend upon the other materials included in the cleaning pad. That is, the nature of the fibers will be such that the cleaning pad exhibits the necessary fluid absorbency. Typically, the use of hydrophilic fibers is preferred. Suitable hydrophilic fibers for use in the present invention include cellulosic fibers, modified cellulosic fibers, rayon, polyester fibers such as hydrophilic nylon (HYDROFIL®). Suitable hydrophilic fibers can also be obtained by hydrophilizing hydrophobic fibers, such as surfactant-treated or silica-treated thermoplastic fibers derived from, for example, polyolefins such as polyethylene or polypropylene, polyacrylics, polyamides, polystyrenes, polyurethanes and the like.

Suitable wood pulp fibers can be obtained from well-known chemical processes such as the Kraft and sulfite processes. It is especially preferred to derive these wood pulp fibers from southern soft woods due to their premium absorbency characteristics. These wood pulp fibers can also be obtained from mechanical processes, such as ground wood, refiner mechanical, thermomechanical, chemimechanical, and chemi-thermomechanical pulp processes. Recycled or secondary wood pulp fibers, as well as bleached and unbleached wood pulp fibers, can be used.

Another type of hydrophilic fiber for use in the present invention is chemically stiffened cellulosic fibers. As used herein, the term “chemically stiffened cellulosic fibers” means cellulosic fibers that have been stiffened by chemical means to increase the stiffness of the fibers under both dry and aqueous conditions. Such means can include the addition of a chemical stiffening agent that, for example, coats and/or impregnates the fibers. Such means can also include the stiffening of the fibers by altering the chemical structure, e.g., by crosslinking polymer chains.

When a fibrous material is used, the fibers may be optionally combined with a thermoplastic material. Upon melting, at least a portion of this thermoplastic material migrates to the intersections of the fibers, typically due to interfiber capillary gradients. These intersections become bond sites for the thermoplastic material. When cooled, the thermoplastic materials at these intersections solidify to form the bond sites that hold the matrix or web of fibers together in each of the respective layers. This may be beneficial in providing additional overall integrity to the cleaning pad.

Amongst its various effects, bonding at the fiber intersections increases the overall compressive modulus and strength of the resulting thermally bonded member. In the case of the chemically stiffened cellulosic fibers, the melting and migration of the thermoplastic material also has the effect of increasing the average pore size of the resultant web, while maintaining the density and basis weight of the web as originally formed. This can improve the fluid acquisition properties of the thermally bonded web upon initial exposure to fluid, due to improved fluid permeability, and upon subsequent exposure, due to the combined ability of the stiffened fibers to retain their stiffness upon wetting and the ability of the thermoplastic material to remain bonded at the fiber intersections upon wetting and upon wet compression. In net, thermally bonded webs of stiffened fibers retain their original overall volume, but with the volumetric regions previously occupied by the thermoplastic material becoming open to thus increase the average interfiber capillary pore size.

Thermoplastic materials useful in the present invention can be in any of a variety of forms including particulates, fibers, or combinations of particulates and fibers. Thermoplastic fibers are a particularly preferred form because of their ability to form numerous interfiber bond sites. Suitable thermoplastic materials can be made from any thermoplastic polymer that can be melted at temperatures that will not extensively damage the fibers that comprise the primary web or matrix of each layer. Preferably, the melting point of this thermoplastic material will be less than about 190° C., and preferably from about 75° C. to about 175° C. In any event, the melting point of this thermoplastic material should be no lower than the temperature at which the thermally bonded absorbent structures, when used in the cleaning pads, are likely to be stored. The melting point of the thermoplastic material is typically no lower than about 50° C.

The thermoplastic materials, and in particular the thermoplastic fibers, can be made from a variety of thermoplastic polymers, including polyolefins such as polyethylene (e.g., PULPEX®) and polypropylene, polyesters, copolyesters, polyvinyl acetate, polyethylvinyl acetate, polyvinyl chloride, polyvinylidene chloride, polyacrylics, polyamides, copolyamides, polystyrenes, polyurethanes and copolymers of any of the foregoing such as vinyl chloride/vinyl acetate, and the like. Depending upon the desired characteristics for the resulting thermally bonded absorbent member, suitable thermoplastic materials include hydrophobic fibers that have been made hydrophilic, such as surfactant-treated or silica-treated thermoplastic fibers derived from, for example, polyolefins such as polyethylene or polypropylene, polyacrylics, polyamides, polystyrenes, polyurethanes and the like. The surface of the hydrophobic thermoplastic fiber can be rendered hydrophilic by treatment with a surfactant, such as a nonionic or anionic surfactant, e.g., by spraying the fiber with a surfactant, by dipping the fiber into a surfactant or by including the surfactant as part of the polymer melt in producing the thermoplastic fiber. Upon melting and resolidification, the surfactant will tend to remain at the surfaces of the thermoplastic fiber. Suitable surfactants include nonionic surfactants such as BRIJ® 76 manufactured by ICI Americas, Inc. of Wilmington, Del., and various surfactants sold under the PEGOSPERSE® trademark by Glyco Chemical, Inc. of Greenwich, Conn. Besides nonionic surfactants, anionic surfactants can also be used. These surfactants can be applied to the thermoplastic fibers at levels of, for example, from about 0.2 to about 1 g/cm² of thermoplastic fiber.

Suitable thermoplastic fibers can be made from a single polymer (monocomponent fibers), or can be made from more than one polymer (e.g., bicomponent fibers). As used herein, “bicomponent fibers” refers to thermoplastic fibers that comprise a core fiber made from one polymer that is encased within a thermoplastic sheath made from a different polymer. The polymer comprising the sheath often melts at a different, typically lower, temperature than the polymer comprising the core. As a result, these bicomponent fibers provide thermal bonding due to melting of the sheath polymer, while retaining the desirable strength characteristics of the core polymer.

Suitable bicomponent fibers for use in the present invention can include sheath/core fibers having the following polymer combinations: polyethylene/polypropylene, polyethylvinyl acetate/polypropylene, polyethylene/polyester, polypropylene/polyester, copolyester/polyester, and the like. Particularly suitable bicomponent thermoplastic fibers for use herein are those having a polypropylene or polyester core, and a lower melting copolyester, polyethylvinyl acetate or polyethylene sheath (e.g., those available from Danaklon a/s, Chisso Corp., and CELBOND®, available from Hercules). These bicomponent fibers can be concentric or eccentric. As used herein, the terms “concentric” and “eccentric” refer to whether the sheath has a thickness that is even, or uneven, through the cross-sectional area of the bicomponent fiber. Eccentric bicomponent fibers can be desirable in providing more compressive strength at lower fiber thicknesses.

In order to allow the cleaning pad to be used with a cleaning instrument, one or attachment strips or other attachment materials are fastened to the top surface of the cleaning pad. The cleaning pad is a single layer pad, so the attachment materials cover only a portion of the top surface of the cleaning pad. In an embodiment, the total surface area of the attachment materials occupies less than 50% of the surface area of the top surface of the cleaning pad, preferably less than 33%, and more preferably less than 25%. In an alternative embodiment, the attachment strips or other attachment materials can be fastened to any surface of the cleaning pad that faces a portion of the cleaning head when attached.

In operation, the attachment materials on the top surface of the cleaning pad secure the cleaning pad to the cleaning head of a mop handle or other cleaning instrument. In an embodiment, the attachment materials of the cleaning pad are in the shape of strips which are attached to complementary attachment strips on the cleaning head. The complementary attachment strips can have substantially the same size and shape as the attachment strips on the cleaning pad. Alternatively, the complementary attachment strips can have a larger surface area than the attachment strips on the cleaning pad.

In an embodiment, the attachment strips and complementary attachment strips are made of a Velcro-type material. The attachment strips can be either a “hooks” surface or a “loops” surface, while the complementary attachment strips have the opposite surface to allow for attachment. The attachment strips can be fastened to the pad using any technique that provides a sufficiently strong bonding. As mentioned above, the cleaning pads are removed from the cleaning instrument after use. Thus, the attachment strips should be fastened to the pad with sufficient strength so that the attachment strips remain fastened to the pad when the pad is removed from the cleaning head of the cleaning instrument. Similarly, the complementary attachment strips should be fastened to the cleaning instrument with sufficient strength to remain in place during removal of a pad. The attachment strips may be bonded to the cleaning pad by any of a variety of bonding techniques, including the use of a uniform continuous layer of adhesive, a patterned layer of adhesive, or any array of separate lines, spirals, or spots of adhesive. In another embodiment, the attachment strips can be stitched to the surface of the cleaning pad using a conventional sewing technique. Alternatively, the attachment strips can be fastened to the cleaning pad using heat bonds, pressure bonds, ultrasonic bonds, dynamic mechanical bonds, or any other suitable bonding technique or combination of techniques that are conventional in the art.

In still another embodiment, the attachment strips are fastened to the cleaning pad using a hot-melt adhesive, such as the DV2000 adhesive available from Devtec Technological Adhesives, Ltd. of Petach-Tikva, Israel. Preferably, the adhesive will have an application temperature of less than 225° C. and tensile and shear strengths of greater than 30 kg/cm². Other suitable adhesives will be apparent to those of skill in the art.

The cleaning pads are suitable for use with a cleaning instrument, such as a cleaning head attached to a conventional mop handle or other type of handle. In an embodiment, the handle for the cleaning instrument can be a telescoping handle. The cleaning head can be attached to the handle by conventional means. In another embodiment, the handle is detachable from the cleaning head.

III. Method of Attaching and Using a Cleaning Pad

The cleaning pads according to this invention allow for cleaning of a surface without the need to separately apply a cleaning solution to the surface. Additionally, the cleaning pads can be easily attached to a cleaning instrument, such as a mop having a handle and a cleaning head.

In an embodiment, the method begins by providing a vessel that contains at least one pad. The vessel can be a bag composed of polypropylene or another suitable polymer/plastic, a plastic container with a lid, or another type of container. In a preferred embodiment, the vessel is a watertight bag or container that can be sealed and resealed. For example, the vessel could be similar in design to a conventional food storage vessel, such as a resealable plastic bag or a container with a lid that forms a watertight seal. Note that the size of the vessel could differ substantially from a typical food storage vessel in order to accommodate the size of the cleaning pad. Preferably, the bag, container, or other vessel also contains a cleaning solution. In an embodiment, the vessel contains not more than 1 kilogram of cleaning fluid. In order to use a pad, the vessel is opened and a pad is removed. The pad is then attached to the cleaning instrument by matching the attachment strips or other materials on the pad with complementary attachment materials on the cleaning head of the cleaning instrument.

After cleaning a surface, or at any other convenient time, the cleaning pad can be removed from the cleaning instrument. The cleaning pad can be removed by pulling the cleaning pad away from the complementary attachment materials of the cleaning head. After removing a used cleaning pad, a new cleaning pad can be attached to the cleaning instrument as described above.

In another preferred embodiment, a cleaning pad can be attached to the cleaning instrument without touching or handling by the user or operator of the cleaning pad. In such an embodiment, a container with a lid that contains at least one cleaning pad is provided. If the container is holding multiple cleaning pads, the pads are preferably stacked one on top of another. This stack is arranged so that the attachment strips or other attachment materials of the top cleaning pad in the stack are exposed. The remaining pads are similarly arranged so that as pads are removed, the attachment strips of each consecutive pad will also be exposed.

Preferably, the container also contains a cleaning solution. The amount of cleaning solution in the container is sufficient to maintain all of the cleaning pads in a saturated state. For example, in an embodiment where the pads are stacked on top of each other, the level of the cleaning solution in the container is preferably above the top surface of the top-most cleaning pad.

In order to attach a pad to a cleaning implement, the lid is opened. The lid can be designed to open to a position and remain in the position, or the lid can be designed to return to a closed position unless an opening force is maintained. After opening the lid, the cleaning head of a cleaning instrument is inserted into the container. In preferred embodiments, at least one of the dimensions of the container opening, such as length or width, is comparable to and slightly larger than one of the dimensions of the cleaning head. Having a container opening with a dimension that is comparable to but slightly larger than a dimension of the cleaning head assists in aligning the attachment materials of the cleaning pad with the complementary attachment materials on the cleaning head. In an embodiment, the vessel has a dimension that is larger than a dimension of the cleaning pad by 5 cm or less. In another embodiment, the vessel has a dimension that is larger than a dimension of the cleaning pad by 3 cm or less. In still another embodiment, the vessel has a dimension that is larger than a dimension of the cleaning pad by 1 cm or less.

After inserting the cleaning head into the container, the operator of the cleaning instrument aligns the attachment materials of the cleaning pad with the complementary attachment materials of the cleaning head. The operator then attaches the cleaning head to the cleaning pad. In an embodiment where the attachment materials are Velcro-type hooks and loops, the cleaning head is attached to the cleaning pad by pressing the complementary attachment materials of the cleaning head down onto the cleaning pad.

After attaching the cleaning pad to the cleaning head, the cleaning pad is withdrawn from the container. The cleaning instrument is now ready for use, such as by wiping a surface to be cleaned with the cleaning pad. As mentioned above, the cleaning pad is saturated with cleaning solution while in the container. Thus, a separate cleaning solution does not need to be applied to a surface to be cleaned. The cleaning pad can be used directly on the surface.

IV. Cleaning Solution

Prior to use, the cleaning pads are immersed in cleaning solution. The cleaning pads are saturated with the solution when withdrawn for use. In an embodiment, the solution is an alcohol based solution, such as an ethanol based solution. Various other constituents can be added to the alcohol based solution to improve the properties of the solution, such as improving the ability to dissolve dirt or stains, reducing the tendency of the solution to foam, or modifying the fragrance of the cleaning solution. In an embodiment, the solution includes disodium cocoamphodiacetate, sodium laureth sulphate, dimethyl dodecyl amino oxide, dipropylene glycol mono methyl ether, n-alkyl dimethyl benzyl ammonium chloride, n-alkyl dimethyl ethylbenzyl ammonium chloride, methylchloroisothiazoline, methylisothiazolinone, benzyl alcohol, 2-bromo-nitropropane-1,3-diol, and fragrance.

In another embodiment, the cleaning solution may consist of a conventional hard surface cleaning composition. Hard surface cleaning compositions are typically aqueous-based solutions comprising one or more of surfactants, solvents, builders, chelants, polymers, suds suppressors, enzymes, etc. Suitable surfactants include anionic, nonionic, zwitterionic, amphoteric and cationic surfactants. Examples of anionic surfactants include, but are not limited to, linear alkyl benzene sulfonates, alkyl sulfates, alkyl sulfonates, and the like. Examples of nonionic surfactants include alkylethoxylates, alkylphenol-ethoxylates, alkylpolyglucosides, alkylglucamines, sorbitan esters, and the like. Examples of zwitterionic surfactants include betaines and sulfobetaines. Examples of amphoteric surfactants include materials derived using imidazole chemistry, such as alkylampho glycinates, and alkyl imino propionate. Examples of cationic surfactants include mono-, di-, and tri-alkyl ammonium surfactants. All of the above materials are available commercially, and are described in McCutcheon's Vol. 1: Emulsifiers and Detergents, North American Ed., McCutcheon Division, MC Publishing Co., 1995.

Suitable solvents include short chain (e.g., C₁-C₆) derivatives of oxyethylene glygol and oxypropylene glycol, such as mono- and di-ethylene glycol n-hexyl ether, mono-, di- and tri-propylene glycol n-butyl ether, and the like. Suitable builders include those derived from phosphorous sources, such orthophosphate and pyrophosphate, and non-phosphorous sources, such as nitrilotriacetic acid, S,S-ethylene diamine disuccinic acid, and the like. Suitable chelants include ethylene diamine tetra acetic acid and citric acid, and the like. Suitable polymers include those that are anionic, cationic, zwitterionic, and nonionic. Suitable suds suppressors include silicone polymers and linear or branched C₁₀-C₁₈ fatty acids or alcohols. Suitable enzymes include lipases, proteases, amylases and other enzymes known to be useful for catalysis of soil degradation.

Another suitable cleaning solution for use with the present implement comprises from about 0.1% to about 2.0% of a linear alcohol ethoxylate surfactant (e.g., NEODOL 1-5®, available from Shell Chemical Co.); from about 0 to about 2.0% of an alkylsulfonate (e.g., Bioterge PAS-8s, a linear C.sub.8 sulfonate available from Stepan Co.); from about 0 to about 0.1% potassium hydroxide; from about 0 to about 0.1% potassium carbonate or bicarbonate; optional adjuvents such dyes and/or perfumes; and from about 99.9% to about 90% deionized or softened water.

In still another embodiment, the cleaning solution can be a cleaning solution adapted for use on wood floors. In such an embodiment, the cleaning solution can comprise water, a wax emulsifier, an anti-slip agent, a detergent or cleaning agent, a solvent to facilitate wetting of the floor by the cleaning solution, preservatives, and fragrance. In yet another embodiment, the cleaning solution can be a cleaning solution adapted for use on tile, linoleum, or other general floor surfaces. In such an embodiment, the cleaning solution can comprise water, a non-ionic surfactant which serves as a cleaning agent, a solvent to facilitate wetting of the floor by the cleaning solution, an anti-slip agent, a chelating agent such as disodium EDTA, preservatives, and fragrance. Wood floor and general cleaning solutions of the above type may be obtained, for example, from Noam Urim Enterprises, Ltd. of Negev, Israel.

In an embodiment, the density of the cleaning solution is from 0.95 g/cm³ to 1.10 g/cm³. In another embodiment, the cleaning solution has a density of at least 0.9 g/cm³, or at least 0.95 g/cm³, or at least 1.0 g/cm³. In another embodiment, the cleaning solution has a density of 1.15 g/cm³ or less, or 1.10 g/cm³ or less, or 1.05 g/cm³ or less. Preferably, the cleaning solution is soluble in either water or ethanol in all proportions. In an embodiment, the pH of the solution is at least 5.0, or at least 5.5, or at least 6, or at least 6.5. In another embodiment, the pH of the solution is 7.5 or less, or 7.0 or less, or 6.8 or less.

V. Vessel for Holding Cleaning Pads

The cleaning solution and cleaning pads are stored in a vessel prior to use. Preferably, the vessel should be watertight to accommodate long term storage of the cleaning pads in cleaning solution. The vessel can be made out of any suitable material, such as polyethylene or other plastics.

In an embodiment, the vessel is large enough so that the entire surface area of the attachment strips of the top cleaning pad is exposed for attachment to a cleaning head. In an embodiment, the length and width of the vessel are large enough so that the cleaning pads can be laid flat and stacked on top of one another within the vessel. In another embodiment, the vessel is large enough to receive the cleaning head of a cleaning instrument.

In an embodiment, at least one of the length and width of the vessel is comparable to but larger than the length and width of the cleaning head of an associated cleaning instrument. This selection for the length and width allows the cleaning head to be inserted into the vessel for attachment of a cleaning pad. In embodiments where the cleaning pads can be removed by inserting the cleaning head into the vessel, this assists in attachment of the cleaning pad by aiding the alignment of the cleaning head with the cleaning pad. In other words, if the dimensions of the vessel are comparable to the dimensions of the cleaning head, the size of the vessel will constrain how the cleaning head is inserted into the vessel. This will aid in aligning the complementary attachment strips on the cleaning head with the attachment strips of the top cleaning pad in the vessel.

In an embodiment, the vessel is a container having a conventional hinged lid. The lid includes a latch to prevent inadvertent opening of the container. In another embodiment, the container has a cantilevered lid. Optionally, the cantilevered lid can be operably connected to a foot pedal. This allows a container sitting on the floor to be opened by someone standing adjacent to the container without having to bend down. This facilitates opening the container while holding a cleaning instrument with a long handle.

To remove a cleaning pad from the container, the container is opened such as by use of the foot pedal. The cleaning head from a cleaning instrument is then inserted into the container. The cleaning instrument is attached to a cleaning pad by aligning the attachment strips on the cleaning pad and the cleaning head. In an embodiment, the dimensions of the container roughly correspond to the dimensions of the cleaning head on a cleaning instrument. In this scenario, the container assists in aligning the cleaning head with the cleaning pad, thus facilitating attachment.

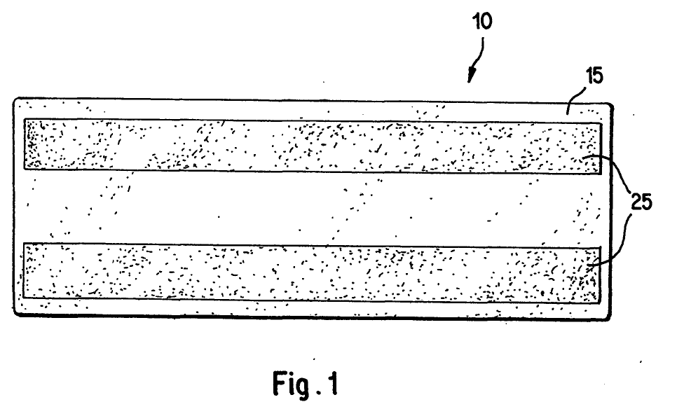

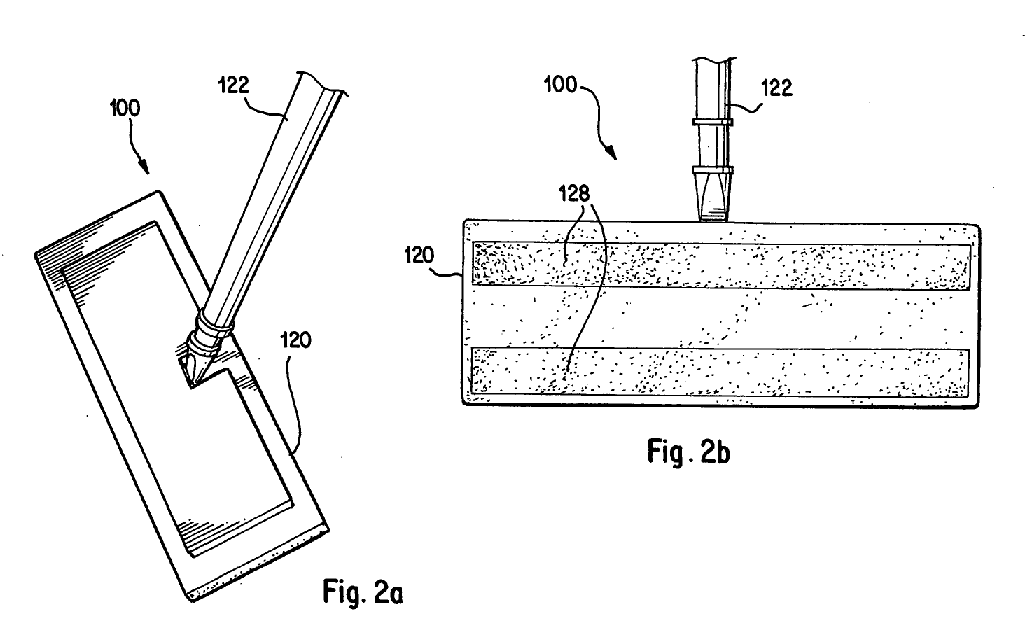

FIG. 1 depicts the top surface 15 of a cleaning pad 10 according to an embodiment of the invention. Two attachment strips 25 are fastened to top surface 15. The attachment strips 25 roughly correspond to the size and shape of the complementary attachment strips 128 shown on the cleaning head 120 of cleaning apparatus 100 in FIG. 2. Cleaning head 120 is secured to a handle 122 for ease of use. To attach cleaning pad 10 to cleaning head 120, the complementary attachment strips 128 of cleaning head 120 are pressed onto attachment strips 25 of pad 10.

FIG. 3 depicts a storage container 130 for holding cleaning pads 10. Storage container 130 includes a main compartment 135 where cleaning pads are held while covered and saturated with cleaning solution. Watertight lid 136 prevents cleaning solution from spilling out of compartment 135 during transit of the storage container. As shown, lid 136 is cantilevered 138 for ease of opening and closing.

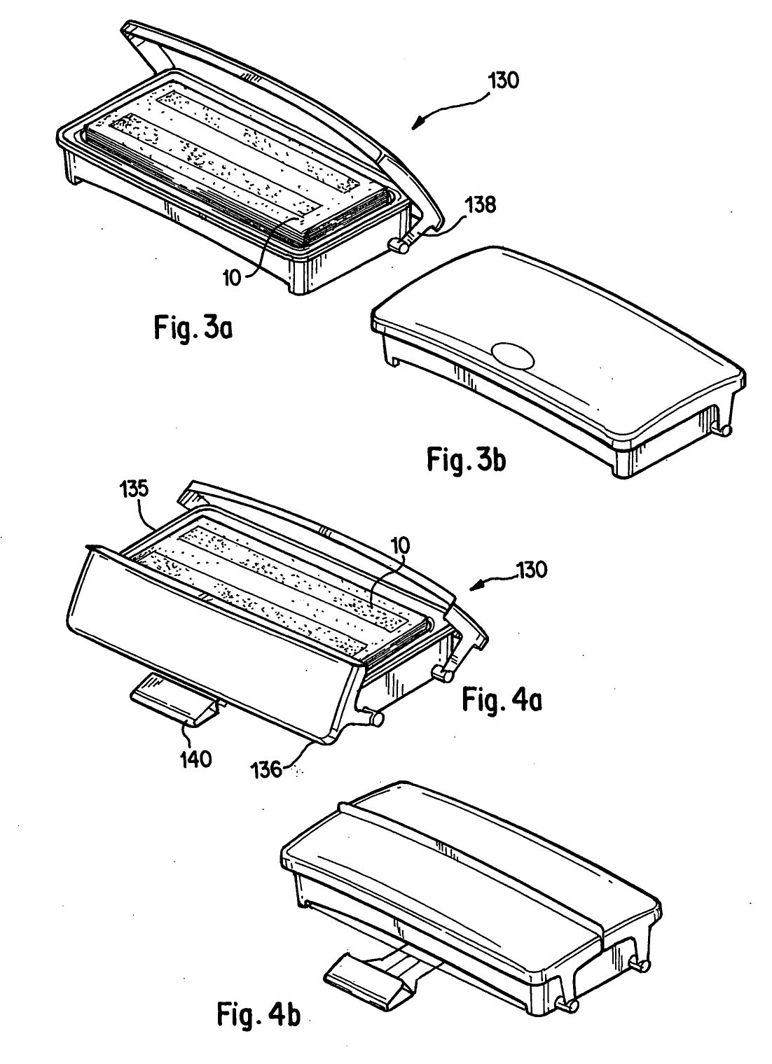

FIG. 4 provides an alternative embodiment of a storage container 130. Here, lid 136 opens in the middle. In this embodiment, lid 136 is opened by depressing foot pedal 140. Foot pedal 140 is operably connected to lid 136 to open the lid when depressed. Releasing foot pedal 140 allows lid 136 to close.

Those skilled in the art will recognize that the above embodiments are merely illustrative, and that variations on the above description may be made while staying within the scope of the present invention.

What is claimed is:

1. A cleaning pad comprising:
a single layer pad having a basis weight of at least 300 g/m², a tensile strength when saturated of at least 200 N, and an adsorbency of less than 8 grams of deionized water per gram of pad at saturation; and
at least one attachment material fastened to a surface of the single layer pad,
wherein the attachment material is a hooks material or a loops material.

2. The cleaning pad of claim 1, wherein the single layer pad has an adsorbency of at least 6.5 grams of deionized water per gram of pad at saturation.

3. The cleaning pad of claim 1, wherein the single layer pad has an adsorbency of at least 7 grams of deionized water per gram of pad at saturation.

4. The cleaning pad of claim 1, wherein the single layer pad has an adsorbency of less than 7.5 grams of deionized water per gram of pad at saturation.

5. The cleaning pad of claim 1, wherein the single layer pad comprises a non-woven material.

6. The cleaning pad of claim 1, wherein the single layer pad is formed by a needle-punch method.

7. The cleaning pad of claim 1, wherein the single layer pad comprises from 40% to 80% rayon, from 0% to 30% polyester, and from 15% to 30% polypropylene.

8. The cleaning pad of claim 7, wherein the single layer pad comprises from 5% to 30% polyester.

9. The cleaning pad of claim 1, wherein the single layer pad comprises from 70% to 80% rayon and from 20% to 30% polypropylene.

10. The cleaning pad of claim 1, wherein the pad is saturated with a cleaning solution.

11. The cleaning pad of claim 1, wherein the at least one attachment material comprises one or more strips of attachment material.

12. The cleaning pad of claim 1, wherein said pad has a tensile strength when saturated of at least 230 N.

13. The cleaning pad of claim 1, wherein said pad has a tensile strength when saturated of at least 250 N.

14. The cleaning pad of claim 1, wherein said pad has a tensile strength when dry of at least 400 N.

15. The cleaning pad of claim 1, wherein said pad has a tensile strength when dry of at least 380 N.

16. The cleaning pad of claim 1, wherein said pad has a tensile strength when dry of at least 350 N.

17. The cleaning pad of claim 1, wherein the elongation of said pad when saturated is less than 65%.

18. The cleaning pad of claim 1, wherein the elongation of said pad when saturated is less than 55%.

19. The cleaning pad of claim 1, wherein the elongation of said pad when dry is less than 75%.

20. The cleaning pad of claim 1, wherein the elongation of said pad when dry is less than 70%.

21. The cleaning pad of claim 1, wherein the basis weight of the pad is at least 315 g/m².

22. The cleaning pad of claim 1, wherein the basis weight of the pad is at least 330 g/m².

23. The cleaning pad of claim 1, wherein the basis weight of the pad is less than 400 g/m².

24. The cleaning pad of claim 1, wherein the basis weight of the pad is less than 375 g/m².

25. The cleaning pad of claim 1, wherein the basis weight of the pad is less than 350 g/m².

26. The cleaning pad of claim 1, wherein the cleaning pad is saturated with a cleaning solution.

27. The cleaning pad of claim 26, wherein the cleaning solution comprises ethanol, disodium cocoamphodiacetate, sodium laureth sulphate, dimethyl dodecyl amino oxide, dipropylene glycol mono methyl ether, n-alkyl dimethyl benzyl ammonium chloride, n-alkyl dimethyl ethylbenzyl ammonium chloride, methylchloroisothiazoline, methylisothiazolinone, benzyl alcohol, 2-bromo-nitropropane-1,3-diol, and fragrance.

28. A method of cleaning a surface comprising:
providing a vessel containing one or more single layer cleaning pads each having at least one attachment material fastened to a surface of the single layer cleaning pad, wherein said cleaning pads are saturated with a cleaning solution;
attaching the cleaning head of a cleaning instrument to the attachment material of a cleaning pad;
withdrawing the cleaning pad from the vessel after attaching the cleaning pad to the cleaning head; and
wiping a surface with the attached cleaning pad.

29. The method of claim 28, wherein the cleaning head of the cleaning instrument comprises at least one complementary attachment material.

30. The method of claim 28, wherein the at least one attachment material is in the shape of a strip.

31. The method of claim 28, wherein the at least one attachment strip is a hooks material or a loops material.

32. The method of claim 28, wherein the at least one attachment material and the at least one complementary attachment material have substantially the same shape.

33. The method of claim 28, wherein attaching the head of the cleaning instrument to the one or more attachment materials of the cleaning pad comprises:
inserting the cleaning head of the cleaning instrument into the vessel, and
pressing the complementary attachment materials of the cleaning head onto the attachment materials of the cleaning pad.

34. The method of claim 28, wherein at least one dimension of the cleaning pad is comparable to at least one dimension of the vessel.

35. The method of claim 34, wherein at least one dimension of the cleaning head is less than 5 cm greater than at least one dimension of the vessel.

36. The method of claim 34, wherein at least one dimension of the cleaning head is less than 3 cm greater than at least one dimension of the vessel.

37. The method of claim 34, wherein at least one dimension of the cleaning head is less than 1 cm greater than at least one dimension of the vessel.

38. The method of claim 28, wherein that adsorbency of the pad is from 6.5 grams to 8 grams of deionized water per gram of pad when saturated.

39. The method of claim 28, wherein the tensile strength of the pad when saturated is at least 200 N.

40. The method of claim 28, wherein the basis weight of the pad is at least 300 g/m²

41. The method of claim 28, wherein the basis weight of the pad is at least 315 g/m².

42. The method of claim 28, wherein the basis weight of the pad is at least 330 g/m².

43. The method of claim 28, wherein the basis weight of the pad is less than 400 g/m².

44. The method of claim 28, wherein the basis weight of the pad is less than 375 g/m².

45. The method of claim 28, wherein the basis weight of the pad is less than 350 g/m².

46. The method of claim 28, wherein the cleaning pad comprises from 70% to 80% rayon and from 20% to 30% polypropylene.

47. A surface cleaning apparatus comprising:
a cleaning head having at least one attachment strip fastened to a surface of the cleaning head;
a handle removably secured to the cleaning head; and
a single layer pad having a basis weight of at least 300 g/m² and a saturated adsorbency of less than 8 grams of deionized water per gram of pad, said single layer pad further comprising at least one complementary attachment strip fastened to a surface of the single layer pad,
wherein said single layer pad is attached to said cleaning head via said attachment strip and said complementary attachment strip.

48. A cleaning pad package assembly, comprising:
a container with a hinged lid;
a plurality of single layer pads arranged within said container having a saturated adsorbency of from 6.5 grams to 8 grams of deionized water per gram of pad, each single layer pad further comprising at least one attachment strip fastened to a surface of the single layer pad, said pads disposed within said container; and
a cleaning solution within said container,
wherein said plurality of single layer pads are saturated with said cleaning solution.

49. A cleaning pad package assembly, comprising:
a watertight container with a cantilevered lid;
a footpedal operably connected to said cantilevered lid;
a plurality of single layer pads arranged within said container having a saturated adsorbency of from 6.5 grams to 8 grams of deionized water per gram of pad, each single layer pad further comprising at least one attachment strip fastened to a surface of the single layer pad, said pads disposed within said container; and
a cleaning solution within said container,
wherein said plurality of single layer pads are saturated with said cleaning solution.
